(19) United States
(12) Patent Application Publication
(10) Pub. No.: US 2025/0217222 A1
(43) Pub. Date: Jul. 3, 2025

(54) ERROR RESOLUTION AND AUTO-CORRECTION FOR UNPROCESSED DATA RECORDS

(71) Applicant: CERNER INNOVATION, INC., Kansas City, MO (US)

(72) Inventors: Indranil SOM, Kolkata (IN); Partha MUKHERJEE, Kolkata (IN); Surajit BHATTACHARYYA, Kolkata (IN); Sabyasachi DAS, Kolkata (IN); Rupa BHATTACHARJEE, Kolkata (IN)

(21) Appl. No.: 18/397,052

(22) Filed: Dec. 27, 2023

(51) Int. Cl. G06F 11/07

(52) U.S. Cl. CPC G06F 11/0769; G06F 11/0745; G06F 11/0793

(57) ABSTRACT

Systems, methods, and other embodiments associated with error resolution and auto-correction are described. In one embodiment, a method includes, for a selected application that was executed by the computing system, accessing a system error log and identifying error messages that occurred during execution. Skipped data records that were not processed are identified. A resolving function is executed to resolve a selected error type that is associated with a group of skipped data records by: identifying an error pattern from an error message and matching it to a database of observed error patterns. In response to a match, retrieving a corrective action that is assigned to the observed error pattern and executing the corrective action to resolve the error on the group of skipped data records. The skipped data records are re-submitted and reprocessed where previous error should be resolved.

### BACKGROUND

Computer systems have been developed to process data records from transactions either in real-time or in batches. A processing engine is typically responsible for executing business logic and/or rules associated with the transactions. This engine may perform calculations, apply business rules, and generate any updates or alerts based on the transaction data. Some systems from large organizations may process thousands of tens of thousands of data records/transactions. The engine may execute different software programs that may be called batch jobs to perform different types of processing on the data records in bulk.

However, there can be processing errors that occur during execution, which results in unprocessed records. These processing errors may be related to environment issues (e.g., memory issues in processing large number of records), configuration issues, and/or application issues (e.g., a logical processing error in the software). Such processing errors cause the processing of certain data records or transactions to stop before completion and be stuck or errored-out in the system. This creates a problem of incomplete tasks and/or unprocessed results from the system, as well as delaying the objectives of the processing system.

In one embodiment, it may be advantageous to have a system that can identify the causes of errors, make appropriate corrections, and re-execute the unprocessed data records to resolve the errors.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of an error resolution system with an auto-correction mechanism.

FIG. 2 illustrates one embodiment of a method associated with the error resolution system of FIG. 1.

FIG. 3 illustrates another embodiment of a method associated with the error resolution system of FIG. 1.

FIG. 4 illustrates one embodiment of graphical user interface associated with the error resolution system.

FIG. 5 illustrates an embodiment of a computing system configured with the example systems and/or methods disclosed.

### DETAILED DESCRIPTION

Systems and methods are described herein that provide an error resolution system for unprocessed data records and/or requests. In one embodiment, the error resolution system monitors a data processing system and provides an auto-correction mechanism for correcting and resolving unprocessed data records and/or requests that were not processed correctly by a transaction processing system. In some scenarios, errors may occur during data record processing that are caused by application logic errors (e.g., inconsistent data issues), system resource errors (e.g., resource deadlock), or other type of error that may occur and be observed in a data processing system.

In one embodiment, the present error resolution system may identify which records were not processed due to an error (also called “skipped records”), identify an error pattern associated with the error, and perform a corrective action on the skipped records to resolve the error. Thus, the skipped records may then be re-processed without the error, and successfully complete the associated transaction(s).

Previous data processing systems would detect an error and generate an error message. However, the data records that were not processed due to the error were simply skipped. No practical resolution mechanism was provided to correct the errors and thus required a human administrator to investigate the errors. Typically, in a client computing system, the unprocessed records went unnoticed for days or weeks until another application/algorithm (e.g., that depended on the results of the skipped records) raised another error condition or would not even execute. This would lead to service tickets being created and submitted to a technology center for manual investigation. Resolution of the errors was uncertain since it was left to the subjective experience of the person handling the error. Overall, many delays were caused in processing the associated transactions.

In one embodiment, the present resolution system provides a technical improvement to these prior data processing systems that includes an auto-correction system for identifying unprocessed/skipped records in real-time or near real-time, resolving error conditions, and re-processing skipped records correctly and to completion in a timely and systematic manner.

In one embodiment, the present resolution system and method may be implemented as a platform to calculate, track, and resolve unprocessed transactions and/or data records that are causing revenue to be stuck within a healthcare revenue cycle system. The present system enables proactive monitoring and automated resolution of error conditions to facilitate faster completion of processing, which may lead to faster revenue realization for a healthcare system.

### System Overview

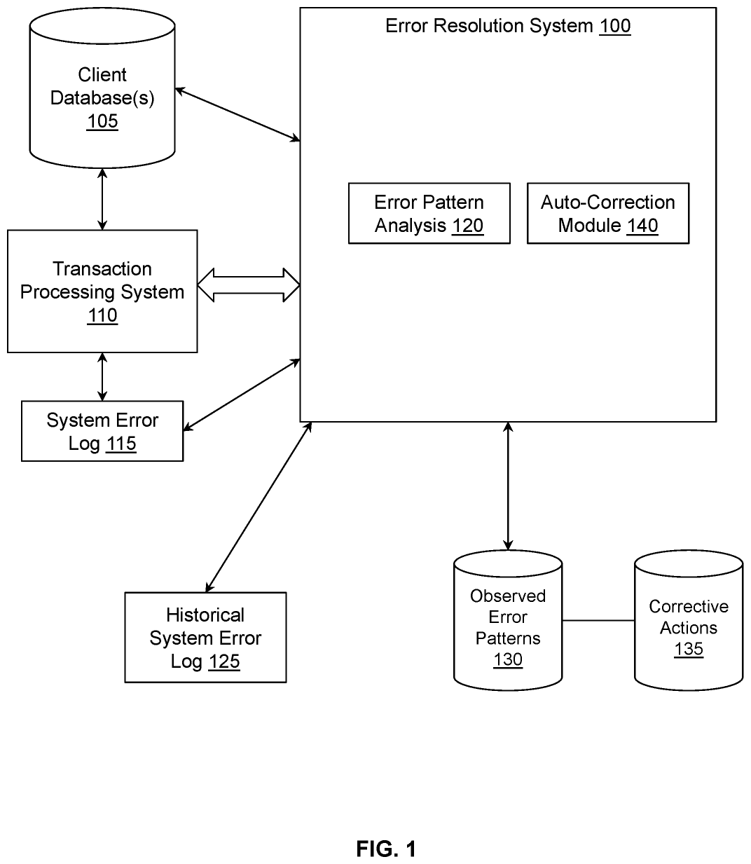

With reference to FIG. 1, one embodiment of an error resolution system 100 is illustrated that is configured to monitor and track unprocessed data records/requests and perform an auto-correction function to resolve errors that caused the data records/requests to be unprocessed. The resolution system 100 may be implemented in a cloud-based computing environment, for example, and provides access to client databases 105 that contain data records associated with a transaction processing system 110.

In general, the transaction processing system 110 is a computing system with one or more applications configured to perform specified actions or operations that a user or another system is requesting to be performed. The client database 105 contains data records, which are units of information, and may include a customer record, a medical record, a sales transaction, or any other pieces of data that the system is configured to handle. When processing a request, the transaction processing system 110 is, for example, performing operations on or with specified data records and/or data tables from the client database 105 with some application logic. The transaction processing system 110 may be executing the operations specified by a request, which may involve one or more data records and various transactions to achieve a specific outcome.

During processing of records/requests, errors may be encountered that cause the associated records/requests to stop processing and be skipped. These are referred to herein as “unprocessed data records/requests,” “unprocessed records,” and/or “skipped records” all of which are synonymous in this description. When an error occurs during processing, an error message is generated and logged in a system error log 115. The error message identifies the error along with other details associated with error. In general, the present error resolution system 100 is not limited to operate with a particular type of transaction processing system 115 and may be configured differently to handle different types of transaction processing systems.

In one embodiment, the resolution system 100 is configured to identify unprocessed records/requests that failed or remained unprocessed because of application or systemic issues. The resolution system 100 diagnoses such issues based on analysis of failures/error messages that are in the system error log 115. Based on the identified issue and type of error, an error pattern is determined. For particular error patterns, a corrective action is performed to resolve the error, for example, by releasing the unprocessed record/request for re-processing, making certain data corrections and reprocessing the records/requests, or performing another type of corrective action based on the error pattern.

### System Error Log Examples

In general, the computer system as well as applications that are executed, are designed to detect events that deviate from expected behavior. These events may include errors, exceptions, warnings, or other abnormal situations. When an event is detected, the system or application triggers an error-handling mechanism. This mechanism could be part of the application code, middleware, or the underlying operating system. The error-handling mechanism includes a logging function responsible for capturing relevant information about the error. This function is designed to record details that can assist in understanding the nature and context of the error. Each log entry may include a timestamp indicating when the error occurred. This helps to establish a timeline of events, especially in systems where errors may have dependencies or relationships with other activities. Errors may be categorized by severity levels such as “critical,” “error,” “warning,” or “informational.” This may help to prioritize and classify the impact of the error on the system.

An error code or identifier may be assigned to uniquely identify the type of error. This code is a reference that can be cross-referenced with documentation to understand the general nature of the error. The error log entry may include a concise error description of the error. This description may provide enough information for a developer or system administrator to understand the context and potential causes of the error.

Additional contextual information may be logged to help understand the circumstances surrounding the error. This may include the user involved, the specific transaction or operation that triggered the error, data objects that were involved in the error (e.g., data records, data tables, files, etc.) and any relevant environmental conditions.

For example, an error description for a deadlock error may state: “An error occurred while populating the data object: Failure in (JDBC) . . . Exception=Transaction (Process ID 123) was deadlocked on lock resources with another process . . . ” In general, a resource deadlock error may occur when one task/process/application is using (and has locked) a resource and another task/process/application cannot access the resource and thus cannot complete its processing.

Another example of an error type may be an Out of Balance (OOB) exception error, which may be caused by a data mismatch error. This error may state: “Runtime OOBB Exception: (description of the condition: Allocated Rev does not match for total receivable allocated revenue amount and total reimbursement . . . ” This description may include table names of the data tables involved (e.g., “Allocated Rev”) in which the calculation mismatch happened. The error message also may include pointers to the table columns involved in the error. For example, the table name “Allocated Rev” has a column name “receivable allocated revenue amount”, or other column name. Table names, column names, files, and/or data records may be identified using a unique Object ID that has been assigned to the data object by the system.

In general, an OOB exception error occurs when there is a mismatch of data or data that is out-of-sync between database tables as part of a transaction or is caused by logical calculation errors. Since this type of error involves different data objects in different types of transaction processing, there are different failure scenarios/patterns for this error type.

In software applications, a stack trace (for software errors) may be included with or in the system error log. This may include a detailed report of the sequence of function calls leading up to the error. It helps to pinpoint the location in the code where the error occurred. The system error log and its error messages are stored in a persistent storage system, such as a log file or a dedicated logging database. In a system that executes jobs and has job names, the error log creation process and the data it contains may be tailored to the specific context of job execution. Additional contextual information related to the job may be logged as part of the error description. This may include parameters, input data, output data, and any other relevant details that can help in understanding the context of the error.

Thus, in one embodiment, the error resolution system 100 is configured with an error analysis module 120 that identifies error patterns using the details from the error messages in the system error log.

### Error Pattern Identification

In one embodiment, during a configuration or learning stage, error pattern analysis 120 may be performed on a set of historical system errors 125 that have been observed over a time period. The error pattern analysis 120 may include a variety of logic components and/or algorithms. For example, a collector component in the platform may be configured to establish asynchronous connections to different client databases 105, the system error logs 115, and/or the historical system error log 125 to collect or extract error messages and/or the unprocessed data records. The system error log 115 and the historical system error log 125 may be the same error log or separated error logs in different embodiments.

Extracting data from the historical system error log 125 (including data from an application stack trace in present) may include extracting features such as timestamps, error types, error codes, error messages, and relevant contextual details. This may be performed, for example, by configuring and submitting queries for designated error messages. The same or similar process would be performed when accessing the system error log 115 when retrieving current error messages from recent executing jobs to resolve errors in real-time, as described below.

The extracted raw log data may be cleaned and preprocessed to handle missing values, to normalize formats, to ensure consistency, and to structure the data in a standard format. The error pattern analysis 120 may then identify and extract features that are relevant to understanding the nature and causes of errors. This might include features like error type, error message, error description, affected system components, affected data tables or objects, and/or contextual information.

In one embodiment, a clustering algorithm or similarity analysis techniques may be used to group similar errors together. Clustering algorithms, such as k-means or hierarchical clustering, can be applied to group errors with similar characteristics. Depending on the approach used, the clusters may be labeled with meaningful categories that represent common causes or types of errors. In another manner, the algorithm may be configured to identify patterns without predefined labels. The identified error patterns may be stored in a database of observed error patterns 130. Each identified error pattern can be stored as a record in the database 130, along with metadata such as the data objects involved in the error, a number of occurrences, timestamps, and any other relevant information.

In one embodiment, an identified error pattern may be based on an error type such as a resource deadlock, a memory issue, a logical error, a configuration issue, or other type error caused by an application error or system error. In another embodiment, the identified error pattern includes additional features combined with the error type to define an error/failure scenario that includes multiple factors relating to the reasons for the error in combination with the error type. For example, a first error pattern/scenario may include a logical error type and includes one or more specific data objects (e.g., specific data tables, specific data fields, specific data records, application running, etc.) that were involved when the logical error occurred.

A second error pattern may include the same logical error type but includes a different set of data tables and/or data fields that were involved when the logical error occurred. Thus, these two examples have the same error type but are different error scenarios/conditions and thus are different error patterns. In this manner, as described below, a specific corrective action may be defined for each error pattern/scenario that is specific to the data objects involved.

Identifying error patterns allows the resolution system 100 to define a collection of failure scenarios from a history of observed errors. The observed errors, which include details of the error and data objects involved, provides a basis to identify different combinations and/or conditions of reasons for a particular error and/or objects involved in the particular error (e.g., data tables, data fields, application process, etc.). The error details are used to identify a specific failure pattern. Examples are provided herein.

The identified error patterns are stored and maintained as a set or collection of observed error patterns 130 or failure scenarios in a database. Of course, for different types of transaction processing systems 110 and/or for different client databases 105 (e.g., different types of data records), the observed error patterns 130 will likely be a different set of error patterns.

After identification, each identified error pattern may then be analyzed, for example, by an administrator, to determine the causes of each error type and the associated conditions or data objects that were involved. Based on this information, a corrective action 135 is configured and assigned to the error pattern for resolving the particular error.

For example, over a time period, the system may see multiple variations or patterns of inconsistent data issues. These issues may also be called data mismatch, out-of-sync data, or in general out of balance OOB exceptions as previously described. When these happen, the error pattern analysis 120 may identify what error messages are placed in the system error log 115 (and/or stack trace) and/or historical error log 125. Based on this analysis and investigations, and what kind of error messages are logged in the error log, the resolution system 100 may correlate between the error log and the exact reason/nature of the issue.

For example, for an error type that is a data mismatch error, the exact reason/nature of issue may be (1) a data mismatch between two specific data tables, (2) a data mismatch across multiple data tables, or (3) other type of inconsistent data issue between different data objects.

For example, if an application/algorithm that is processing data is using three (3) data tables in its calculations, based on a particular calculation or a financial transaction, the algorithm may be configured to expect the summation of certain fields in two data tables (e.g., table A and table B that have data field 1 and field 2, respectively) to be equal to some other data field 3 in table C (based on some formula). If the sum of field 1 and field 2 do not equal the value in data field 3, then a data mismatch error occurs, and further processing is skipped/bypassed for that data record/request that are involved. The generated error message in the system error log 115 may include the type of error (e.g., data mismatch or inconsistent data values) and identifies the data objects involved in the error (e.g., table A, field 1, table B, field 2, and table C, field 3). These features from the error message may be used to generate an observed error pattern.

The following is another error pattern/scenario example with the same error type but different reasons or nature of the error. Suppose the algorithm processing data records is configured to expect the summation of the two fields in the two data tables (e.g., tables A and B that have data fields 1 and field 2, respectively) to be equal to the value in data field 3 in table C but as a negative value. If the sum of field 1 and field 2 equal the value in data field 3 but the value is not negative, then a data mismatch error occurs. But in this example, the reasons/nature/conditions of the issue are different than the previous example above. Thus, these would be two different observed error patterns and each one will have a different corrective action even though the error type (a data mismatch) is the same for both.

By knowing and identifying the error pattern, an appropriate corrective action is determined to fix the error, which in this case may involve modifying the incorrect data in the relevant table(s) or data field, or revising the algorithm/logic that calculated the data (if the formula is incorrectly programmed). Thus, for certain types of reoccurring errors, it can be determined exactly which data field in which table has a wrong value in it.

Thus, the corrective action involves correcting the data field that is wrong and reprocessing the transaction. The corrective action is then assigned to the particular observed error pattern 130 and stored in the collection of corrective actions 135. A set of corrective actions 135 may be defined where each correction action is assigned to one or more observed error patterns 130 to resolve the particular error associated with the observed error pattern.

Thus, based on the system error log 115 (which may include the application stack trace and analysis of the data in the relevant tables), the system learns and obtains these error patterns/scenarios, which may be associated with different use cases. The above process may be repeated for other error patterns and their associated corrective actions may be defined and stored. Thus, the resolution system 100 contains a collection of failure scenarios as observed error patterns 130 and their corresponding corrective actions 135.

As will be described below, the corrective actions 135 may be used by an auto-correction module 140 to automatically correct processing errors that match one of the observed error patterns 130. In operation, when the resolution system 100 sees the same error pattern in a real-time transaction that matches a known observed error pattern 130, then the appropriate corrective action 135 may be performed to resolve that error and reprocess any unprocessed records/requests that are associated with that error pattern. This is described in more detail below.

In another embodiment, the error pattern analysis 120 may be configured with a machine learning (ML) algorithm to identify error patterns and likely errors along with what caused the error. This may include extracting and gathering raw data from the error logs, transforming the raw data to make it suitable for machine learning including cleaning the data and transforming the structure into a recognized format. Relevant features may be extracted from the transformed error log data to feed into the machine learning algorithm. Features may include a type of error, frequency of occurrences, time of day, data objects involved, and/or any other relevant information as previously discussed that may help in identifying patterns. In one embodiment, feature vectors may be generated from the error log features for input to the ML algorithm so that the input has the same format.

In one embodiment, the resolution system 100 may be implemented with a healthcare transaction system that includes a revenue cycle system. In a revenue cycle system, charges are posted towards treatment of a patient from medical encounter records, and then the transaction flows through different workflows (e.g., applications, modules, or logic). These workflows may include applications for Reimbursement Management, Charge Grouping, Receivables Management, Claims Generation, Guarantor Account Management, Bills and Statements Generation etc. that process medical records before an insurance claim and/or a guarantor statement is transmitted out to a designated company or person for payment of the charge.

Each of these workflows processes the charges in a different manner, and there can be processing errors related to a variety of issues. Example issues that cause an error may include, but are not limited to, environment issues (e.g., resource or memory issues in processing a large number of charges), configuration issues (e.g., logic rules defining how changes will be grouped together), and application issues (e.g., logical processing errors like calculation of expected reimbursement). When any such error occurs, an error message is generated in the system error log and/or stack trace, and the data record involved in the error is skipped (unprocessed). Furthermore, a program that processes the charges of the skipped records (e.g., charge processing) may also be skipped and is now stuck/blocked in the system from being processed.

This results in unprocessed revenue and delay in revenue realization since the skipped records correspond to charge amounts. The charge amount from a skipped record is referred to herein as impacted revenue. In some systems that process thousands of records, it is not uncommon for hundreds of data records to be skipped due to errors during a processing cycle, which when aggregated may amount to a very large sum of impacted revenue.

In one embodiment, the resolution system 100 is configured to identify the error patterns/scenarios in such a healthcare system and to resolve the errors with a corresponding corrective action. The resolution system 100 is configured to monitor and retrieve real time unprocessed revenue information from one or more client databases to proactively monitor and resolve the errors associated with the unprocessed records/requests. In one embodiment, the resolution system 100 is configured to access and fetch designated error information and associated data records automatically via network communications with the system error log 115 and client databases 105 in real-time or near real-time.

Such retrieval and analysis were not possible in prior healthcare processing systems because they relied on manual effort to investigate error logs, which would take several hundreds of hours of effort. In fact, manual effort would never have been able to facilitate the level of monitoring across all multiple client databases that the present error resolution system 100 has enabled.

Furthermore, prior transaction systems had no implemented technique to identify error patterns from system error logs and perform an appropriate corrective action as described herein. These are some of the technical improvements provided by the present error resolution system.

### Auto-Correction Embodiment

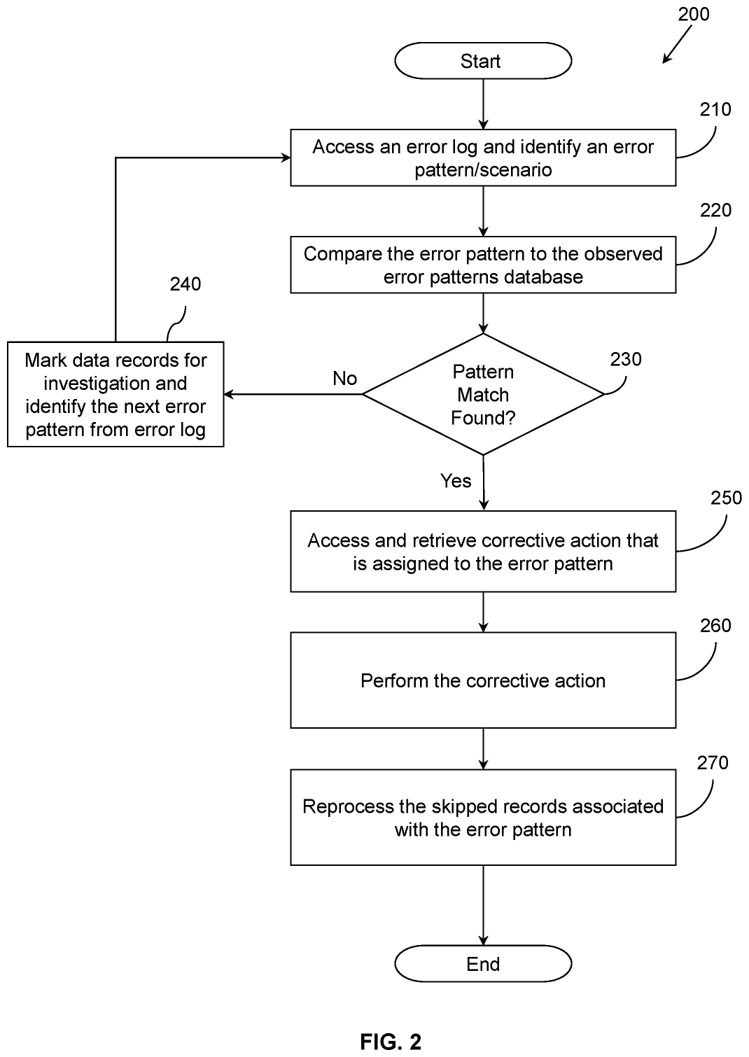

With reference to FIG. 2, one embodiment of an auto-correction method 200 is illustrated that is associated with the resolution system 100 of FIG. 1. Method 200 is described from a viewpoint of the resolution system 100 being invoked or initiated automatically through an implicit day-end batch job after a processing cycle is completed or being invoked by a user via a graphical user interface that is configured with the resolution system 100. Typically, during a transaction processing cycle, programs are executed on data records and any errors that occur or are triggered cause the system to generate and store an error message in a system error log and/or stack trace as previously described.

At block 210, the auto-correction method is initiated and the system error log and/or stack trace are accessed. Error messages are analyzed to identify error patterns/scenarios. This may include the same or similar error pattern recognition process as performed by the error pattern analysis component 120 of the resolution system 100. Error messages from the system error log 115 are retrieved and features from each error message are extracted as previously explained. The features are constructed into a similar format that can be compared to the format of the observed error patterns 130 previously generated.

In one embodiment, a set of structured queries may be defined for requesting designated data from one or more target client databases 105. The queries may be defined and submitted to obtain the designated data and/or associated reports related to skipped records that are involved with the error messages.

The skipped data records associated with each error message may also be retrieved including data identifying an impacted result from being skipped and not processed to completion. For example, in the healthcare transaction system above, the impacted result of skipped data records is the associated charge amount, which is found in one or more data fields of the skipped data records. The associated charge amount corresponds to the impacted revenue that is unprocessed due to the data record being skipped.

In one embodiment, a processor-transform component may be provided and configured as a two phased platform activity. This component is configured to process the collected data into a text file, which may then be scanned for any data discrepancy and data verification. The text file may be transformed into a standard report (e.g., Microsoft Excel spreadsheet or other format). This report may contain the final unprocessed revenue data determined from the skipped records and is made available via network communication. A graphical user interface may be configured to provide access to the data by report subscribers and/or stakeholders from remote locations.

In another embodiment, the processed and extracted data may be archived and loaded by saving the data in a shared file system as an archive file. The extracted data from skipped records may also be stored in a dedicated on-premises relational database (RDBMS). Once the structured data is persisted/loaded within the system, integration of the revenue data is easily handled as the data is stored in a common storage location (e.g., data-lake) from where it can be connected to and accessed by different application dashboard user interfaces within the system network.

At block 220, after one or more error patterns are identified from the system error log (e.g., real-time error messages), the identified error patterns are compared to the observed error patterns 130 contained in the database. In one embodiment, the comparison may include executing a comparison algorithm that evaluates the similarity between the features of an input error pattern from a real-time error message and those of the known observed error patterns 130. The choice of algorithm depends on the nature of the features and the desired level of accuracy. Example algorithms may include cosine similarity, Euclidean distance, or a custom algorithm tailored to specific feature types of the error messages for a particular system.

In one embodiment, a similarity threshold may be established to determine when a match is considered significant. The threshold may represent a minimum level of similarity required to identify a match. This threshold can be adjusted based on the application's requirements and an acceptable margin of error. The features of the input error pattern are compared with each known observed error pattern 130 until a match is found or until all comparisons are made and no match is found.

If no match is found, then the method moves to block 240 where the method may flag, mark, and/or log the error message and its associated skipped data records for investigation. Since an error pattern match was not found, the system does not have a corrective action defined to resolve the particular error pattern. The skipped data records may be listed and maintained in a log for manual corrective action. These errors (error patterns) have no automated corrective action configured yet in the system, but may be defined and added in the future.

If the similarity analysis meets or exceeds the established threshold with a particular observed error pattern 130, the system considers it a match. The system may then flag, mark, or log the matched error pattern. The method moves to block 250 where a corrective action that is assigned to the observed error pattern is retrieved. This may include accessing the collection of corrective actions 135 and retrieving the corrective action associated with the observed error pattern that was matched.

At block 260, the corrective action is performed. As previously explained, various types of corrective actions may have been defined for different error patterns to resolve the specific error that occurred. For example, for a resource deadlock error, the corrective action may be to simply resubmit the data records to have the system reprocess the skipped records. The assumption is that different computing resources will be available at different times. Thus, a reprocess may automatically resolve some or all the previous deadlock errors because the previously unavailable resources (which caused the deadlock) may now be available. Once the error is resolved, the skipped data records should then be processed correctly and to completion without an error.

At block 270, the skipped data records associated with the error pattern that has been corrected are sent back to the transaction system and reprocessed. If the corrective action resolves the error condition, then the same error message(s) will not appear in the system error log. In one embodiment, this may be determined by re-executing the error pattern analysis to identify if the previous error pattern is still found in the system error log or not. If same error is not found, then the error pattern was resolved and the skipped data records associated with the error pattern were now processed to completion. In one embodiment, a pop-up window may be generated and displayed on the GUI that shows no errors were found for that particular error type or error pattern, thus verifying that the corrective action resolved the error condition.

If the same error pattern is again found in the system error log, then the corrective action did not resolve the error. In this case, the resolution system may reverse any data changes or modifications that were being made by the corrective action to roll-back the system and/or data back to its previous state. The error pattern may then be marked and logged for investigation, and an error message may be generated indicating that the corrective action was not proper.

Overall, with the resolution system 100 and auto-correction method 200, the system analyzes and determines the reasons for failure and/or non-processing of data records/requests that are responsible for impacting some resource, for example, revenue generation and flow. The system attempts to automatically correct errors to ensure that some or all of the unprocessed records/requests that errored out are identified and reprocessed after an appropriate corrective action. Thus, the resolution system 100 may automatically correct errors in a transaction processing system.

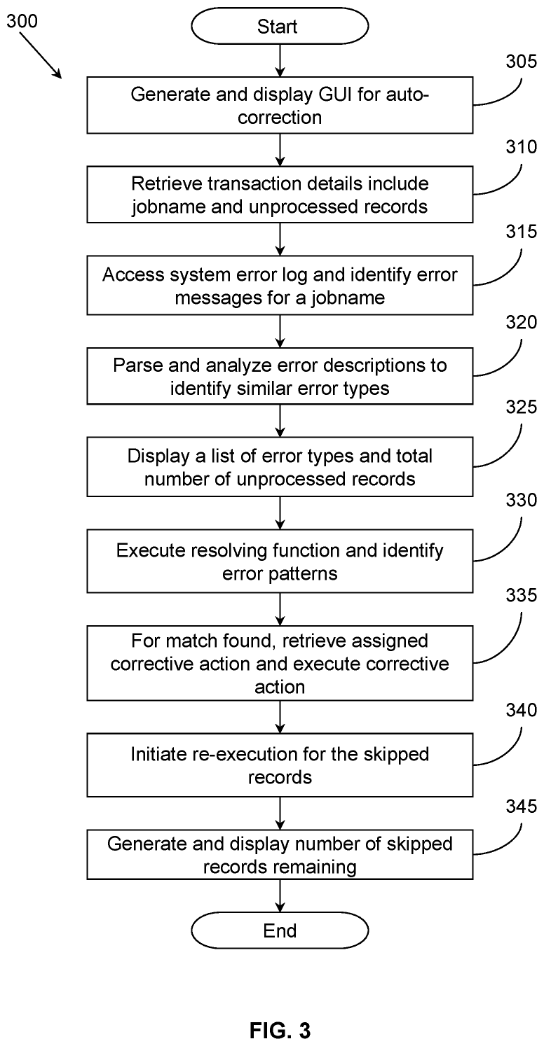

With reference to FIG. 3, another embodiment of an auto-correction method 300 is illustrated. The resolution system 100 and the auto-correction module 140 may be configured to perform the auto-correction method 300 on a live system to resolve errors for unprocessed data records/requests. In one embodiment, the auto-correction method 300 may be invoked or initiated automatically after a processing cycle is completed or may be invoked by a user via a graphical user interface that is configured as part of the resolution system 100 or other user interface option.

The following example will be described with reference to a transaction processing system that is a healthcare transaction processing system that includes a revenue cycle system. As previously described, medical data records may include a charge amount associated with a medical encounter, service, or procedure performed for a patient corresponding to the medical data record. If a medical data record is not processed and/or errored out due to some error, the charge amount is also unprocessed and becomes part of an amount of impacted revenue caused by the unprocessed records and error.

At block 305, after auto-correction is initiated, a graphical user interface (GUI) is generated and displayed on a display screen. The GUI includes a selectable option to select and access a computing environment that includes data records/requests associated with transactions that have been processed by the computing system. The computing environment may be a list of available application builds for one or more different client databases of data records where each different client includes transactions processed (e.g., jobs run by the application build) that are associated with a client. An application build may include one or more of the workflows mentioned previously.

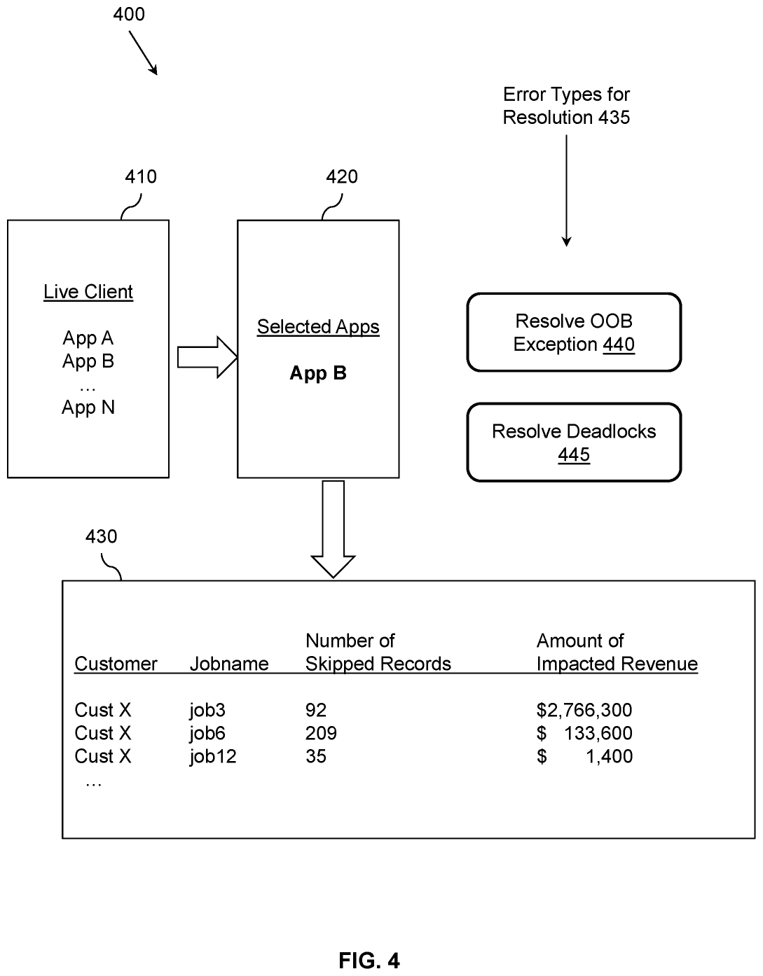

For example, with reference to FIG. 4, one embodiment of a graphical user interface (GUI) 400 is illustrated that shows a home screen with selectable options to initiate the resolution system and auto-correction tool on a selected client and/or transaction. The computing environment may include a “live client” list 410 that lists different application builds (e.g., App A, App B, App N). The application builds are executable software applications that are available for processing transactions on client data records/requests. The list may also identify a release version of each application. Each application build may be referred to as an “environment” that can be selected and then the auto-correct tool may be executed on that environment. The application builds/environments selected by a user for auto-correction may be listed in window 420.

At block 310, for the selected application builds/environments in window 420 (FIG. 4), transaction details are retrieved from the transactions processed by the application build. The transaction details may include a job or process name that is assigned to each specific workflow, process, job or task executed within the transaction processing system. Jobname and process name are synonymous and interchangeable herein. The transaction details may also include a number of unprocessed records/requests that identifies a number of skipped data records that were part of the executed jobname but were not processed to completion due to an error.

In the context of the healthcare revenue cycle system, the transaction details may include claim details from the selected application build/environment (e.g., “App B”). With reference again to FIG. 4, in response to selecting “App B” in window 420, the GUI 400 generates a pop-up window or a new GUI page that displays the transaction details from App B in transaction details table 430. The details may be displayed to include various job or process details, for example, Customer Name, Job or Process name, Number of Skipped Records that occurred during the associated job that processed the data records, and a value of impacted revenue. This may be displayed in a table format or other structure.

As seen in table 430, Jobname “job3” has 92 skipped records (unprocessed records) with a total of $2,766,360 of impacted revenue. Thus, the impacted revenue is an amount of revenue that is currently unrealized due to one or more errors during processing. In other words, the impacted revenue amount is currently blocked or held up in the system since the associated medical records were not processed to completion during the job run/execution. Similarly, “job6” has 209 skipped records and $133,600 of impacted revenue caused by one or more errors during processing.

In one embodiment, the error resolution system accesses and analyzes the skipped data records to identify the impacted revenue. For example, from each skipped data record, the system identifies data fields that identify total charge amounts and/or revenue amounts associated with the skipped data records. By summing the total charge amounts from a group of skipped data records, the system determines the impacted revenue amount that is caused by the skipped data records not being processed. The system may then display, on the graphical user interface 400, the impacted revenue amount associated to the skipped records count in table 430.

For some medical records, an error may occur early in the processing such that the system does not reach a point to calculate the associated charge amount. Thus, there may be multiple skipped records that have no impacted revenue (zero value) that was determined, but in reality, the value may be much higher.

Once the transaction details table 430 is generated, a user may select one or more rows, for example, by selecting one of the jobnames. The resolution system 110 is configured to retrieve and display error details for the selected jobname.

With reference again to FIG. 3, at block 315, in response to a jobname (e.g., row) being selected, the system accesses the system error log and/or application stack and identifies error messages that occurred during the execution of the selected jobname. This may include submitting a query request and/or other network communication for access to the data in the system error log. For example, a query may request all error messages that belong to the selected jobname and the system would return those error messages as a query result. In another embodiment, the system error log may be accessed and parsed to identify the error messages associated with the selected jobname by, for example, matching the jobnames.

In another embodiment, the GUI 400 (FIG. 4) may include selectable options for selecting a particular error type that a user wishes to resolve (e.g., error types for resolution 435). For example, the resolution system 100 may be configured to resolve a set of particularly known errors and display those options as selectable menu items. In one embodiment, the GUI 400 is configured to generate and display a list of error types as selectable options to resolve the error type. The list may be determined based on the known error types that were determined with the known observed error patterns 130 (FIG. 1), which have a corrective action. The selectable option is configured to initiate the execution of the corrective action on the group of skipped data records and to initiate the re-execution of the group of skipped data records to be reprocessed after the corrective action is performed.

FIG. 4 shows two selectable error types: Resolve OOB Exception 440 and Resolve Deadlocks 445 but the system is not limited to these error types. In response to the user selecting one of the error types for resolution, the system may initially filter the error messages from the system error log 115 to error messages that match the selected error type for resolution.

With reference again to FIG. 3, at block 320, the error messages are retrieved from the system error log. In one embodiment, the error messages may be displayed on the GUI 400 at this point. The messages and their error descriptions may be parsed and analyzed to identify error types. In one embodiment, each error message may include various details of the error such as jobname, error type, and may include an error description as previously described. Error messages may also include a bypass object ID that identifies a data object (e.g., data table, column, data record, file, etc.) associated with the skipped data record involved in the error.

Selected features from each error message are extracted as previously explained to prepare for error pattern identification. The features are constructed into a similar format that can be compared to the format of the observed error patterns 130 previously generated by the resolution system 100 (shown in FIG. 1). In one embodiment, the resolution system 100 parses and analyzes the error descriptions from the error messages to identify error messages that have the same or similar error type based on at least keywords that are similar. In another embodiment, the system may search for particular error types based on a set of known error types that were previously defined.

At block 325, the system displays, on the GUI 400, a list of error types found and may aggregate the error details by error type to provide a summary of each error type. Each found error type may be displayed on the GUI 400. For example, one row may identify a deadlock error as an error type and display a total number of skipped records associated with the deadlock error type.

Another error type may be a data mismatch error (e.g., OOB exception error) and a total number of skipped records associated with that error type is displayed. For each error type, the system may also display an aggregated total for the impacted resource associated with all the skipped records that were not processed to completion due to the particular error type. In this example, the impacted resource is impacted revenue.

Thus, the resolution system 100 may group/filter the error records together by error type based on key words such as “deadlock.” Of course, some error message details that involve a deadlock error may not have identical descriptions but are similar. Grouping the error messages by error type (e.g., error description) provides an improved visual representation for a user to understand the errors.

For example, with reference to FIG. 4, the error messages for “job6” may be retrieved and, after analysis, the system finds five different types of errors occurred during processing. The five error types caused the 209 skipped records of job6. Thus, five line items (five error types) may be displayed rather than displaying hundreds of individual error messages on the GUI. Aggregating the charge amounts from the five different error types would equal the total amount of impacted revenue $133,600 shown in table 430.

With reference again to FIG. 3, at block 330, a resolution function is executed to resolve one or more of the error types that were found. The system may execute the resolution function in response to the user initiating the resolution for a particular error type. For example, the user may select Resolve Deadlocks 445 (shown in FIG. 4) to initiate the resolution of deadlock errors.

In one embodiment, the resolving function performs error pattern matching similar to the error pattern analysis 120 (FIG. 1). This includes (1) identifying an error pattern associated with the individual error messages having the selected error type from the real-time system error log, and then (2) matching the error pattern to the known observed error patterns 130. As previously described, the error messages describe reasons for the error and features are extracted from the error messages. The extracted features define the error pattern for the current error message. The error pattern is then compared to the known observed error patterns in the database of observed error patterns.

For example, the error pattern matching may determine that the error type is a data calculation error that causes a mismatch of data or out-of-sync data between database tables. From the error message and error description, the names of the database tables and/or data columns are identified. These features are extracted and form part of the error pattern for this error message. As described below, a corrective action for such an error may include modifying one or more data values associated with the identified database tables based on the error pattern found in the error message from the skipped data records.

If no match is found for the real-time error pattern, then the system may flag, mark, and/or log the error message and its associated skipped data records for investigation. This is similar to block 240 in FIG. 2. Since an error pattern match was not found, the system does not have a corrective action defined to resolve the particular error pattern.

At block 335, if a match is found, they system may mark the error message as a match and retrieve a corrective action that is assigned to the matching observed error pattern from the collection of corrective actions 135 (FIG. 1). Then, the retrieved corrective action is executed to resolve the error for the group of skipped data records.

For example, for a resource deadlock error, the corrective action may be to simply resubmit the skipped records to be processed again. The assumption is that different computing resources will be available at different times in the computing system. Thus, reprocessing the skipped records may automatically resolve some or all the deadlocks because the previously unavailable resources (which caused the deadlock) may now be available. Once the error is resolved, the skipped data records should then process correctly and to completion without a deadlock error. Thus, a reprocess will automatically resolve deadlocks.

In another error example, as previously explained, an OOB exception error may occur when processing logic causes a mismatch of data or data that is out-of-sync between database tables as part of a transaction or is caused by logical calculation errors. Since this type of error involves different data objects (e.g., data records, data tables, data columns/fields, etc.) that are involved in different types of transaction processing, there are different scenarios/patterns for this error. To resolve this type of error with a particular error pattern, the corrective action may include modifying a data table and/or data field in a particular manner as previously determined and defined in the associated corrective action.

At block 340, after the error pattern match is found and the corrective action(s) has been performed, the system initiates re-execution of the application or task involved in the error(s) to reprocess the group of skipped data records. In one embodiment for one type of error, re-execution may include identifying request objects that were involved in the group of skipped data records that had an error while processing and re-execute the request objects and/or re-invoke the request object for processing.

At block 345, the system may generate and display a total number of skipped data records that remain after re-execution. In one embodiment, after reprocessing the skipped data records, the resolution system 100 may access the system error log to identify and determine a new total number of skipped data records that remain for the selected error type. If more skipped records remain, the process may be repeated until no further error patterns are matched to the known observed error patterns 130. When none of the real-time error patterns match with a known observed error pattern, this indicates that there are no corrective actions in the system to resolve the particular remaining errors.

If the same or similar number of skipped records are found or if the same error pattern is found again in the system error log, this may indicate that the corrective action did not resolve the error. In this case, the resolution system reverses any data changes or modifications that may have been made by the corrective action to roll-back the system and/or data back to its previous state. The error pattern may then be marked and logged for investigation, and an error message may be generated indicating that the corrective action was not proper.

In general, the present error resolution system and methods provide an advanced technical implementation of a self-healing functionality where the system performs auto-correction and auto-reprocessing of specific unprocessed requests/records in a transaction processing system. The system is a technical improvement and solution that solves the technical problems associated with technical errors that occur during transaction processing.

### Cloud or Enterprise Embodiments

In one embodiment, the resolution system 100 is a computing/data processing system including an application or collection of distributed applications for enterprise organizations. The applications and computing system may be configured to operate with or be implemented as a cloud-based networking system, a software as a service (SaaS) architecture, or other type of networked computing solution. In one embodiment the resolution system is a centralized server-side application that provides at least the functions disclosed herein and that is accessed by many users via computing devices/terminals communicating with the computing system 100 (functioning as the server) over a computer network.

In one embodiment, one or more of the components described herein are configured as program modules stored in a non-transitory computer readable medium. The program modules are configured with stored instructions that when executed by at least a processor cause the computing device and/or processor to perform the corresponding function(s) as described herein.

### Computing Device Embodiment

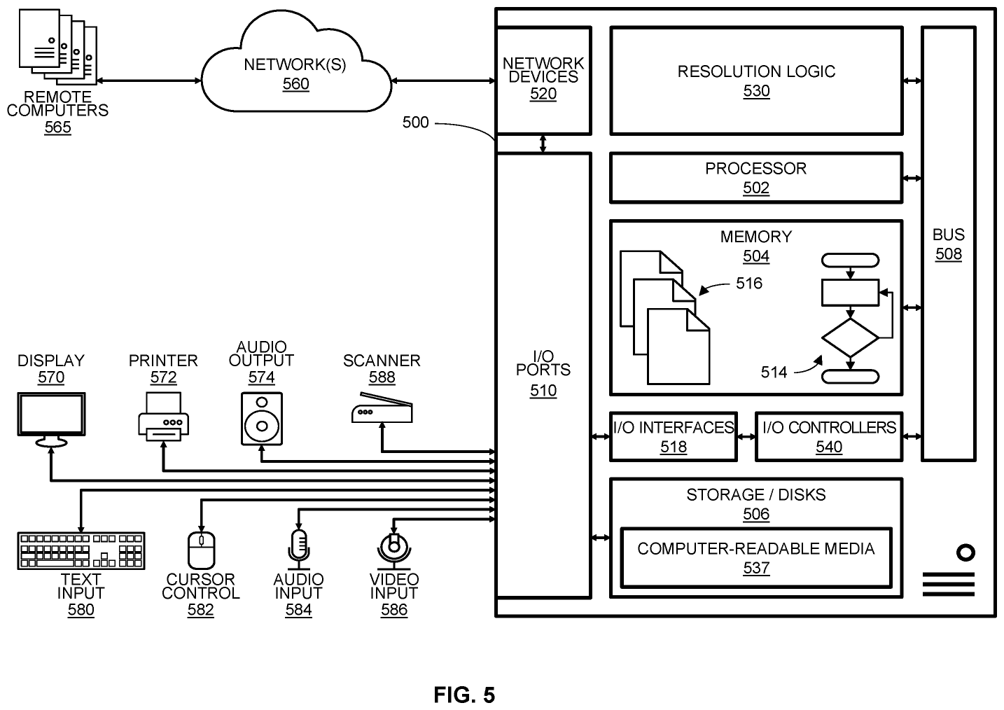

FIG. 5 illustrates an example computing device that is configured and/or programmed as a special purpose computing device with one or more of the example systems and methods described herein, and/or equivalents. The example computing device may be a computer 500 that includes at least one hardware processor 502, a memory 504, and input/output ports 510 operably connected by a bus 508. In one example, the computer 500 may include error resolution logic 530 configured to facilitate an auto-correction on processing errors similar to the error resolution system 100 and methods shown in FIGS. 1-4.

In different examples, the logic 530 may be implemented in hardware, a non-transitory computer-readable medium 537 with stored instructions, firmware, and/or combinations thereof. While the logic 530 is illustrated as a hardware component attached to the bus 508, it is to be appreciated that in other embodiments, the logic 530 could be implemented in the processor 502, stored in memory 504, or stored in disk 506.

In one embodiment, logic 530 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to perform error resolution and auto-correction as described herein. The means may also be implemented as stored computer executable instructions that are presented to computer 500 as data 516 that are temporarily stored in memory 504 and then executed by processor 502.

Logic 530 may also provide means (e.g., hardware, non-transitory computer-readable medium that stores executable instructions, firmware) for performing one or more of the disclosed functions and/or combinations of the functions.

Generally describing an example configuration of the computer 500, the processor 502 may be a variety of various processors including dual microprocessor and other multi-processor architectures. A memory 504 may include volatile memory and/or non-volatile memory. Non-volatile memory may include, for example, ROM, PROM, and so on. Volatile memory may include, for example, RAM, SRAM, DRAM, and so on.

A storage disk 506 may be operably connected to the computer 500 via, for example, an input/output (I/O) interface (e.g., card, device) 518 and an input/output port 510 that are controlled by at least an input/output (I/O) controller 540. The disk 506 may be, for example, a magnetic disk drive, a solid state disk drive, a floppy disk drive, a tape drive, a Zip drive, a flash memory card, a memory stick, and so on. Furthermore, the disk 506 may be a CD-ROM drive, a CD-R drive, a CD-RW drive, a DVD ROM, and so on. The memory 504 can store a process 514 and/or a data 516, for example. The disk 506 and/or the memory 504 can store an operating system that controls and allocates resources of the computer 500.

The computer 500 may interact with, control, and/or be controlled by input/output (I/O) devices via the input/output (I/O) controller 540, the I/O interfaces 518, and the input/output ports 510. Input/output devices may include, for example, one or more displays 570, printers 572 (such as inkjet, laser, or 3D printers), audio output devices 574 (such as speakers or headphones), text input devices 580 (such as keyboards), cursor control devices 582 for pointing and selection inputs (such as mice, trackballs, touch screens, joysticks, pointing sticks, electronic styluses, electronic pen tablets), audio input devices 584 (such as microphones or external audio players), video input devices 586 (such as video and still cameras, or external video players), image scanners 588, video cards (not shown), disks 506, network devices 520, and so on. The input/output ports 510 may include, for example, serial ports, parallel ports, and USB ports.

The computer 500 can operate in a network environment and thus may be connected to the network devices 520 via the I/O interfaces 518, and/or the I/O ports 510. Through the network devices 520, the computer 500 may interact with a network 560. Through the network, the computer 500 may be logically connected to remote computers 565. Networks with which the computer 500 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations based on the disclosure.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A non-transitory computer-readable medium that includes stored thereon computer-executable instructions that when executed by at least a processor of a computer cause the computer to:
generate and display, on a display screen, a graphical user interface that includes an option to select a computing environment that includes transactions that have been processed on a set of data records;
retrieve transaction details including a jobname that is assigned to each of the transactions processed and a skipped records count that identifies a number of skipped data records that were not processed to completion during execution of the jobname;
for a selected jobname, access a system error log and identify error messages that occurred during execution of the jobname, wherein the error messages include an error description;
parse and analyze the error descriptions from the error messages to identify error messages that have the same or similar error type;
display, on the GUI, a list of error types that aggregate the error descriptions by error type and display a total number of skipped records associated with each error type;
execute a resolving function to resolve a selected error type by:
performing an error pattern match by identifying an error pattern associated with an error message that describes reasons for the error and comparing the error pattern to a database of observed error patterns;
if a match is found, mark the error message as a match and retrieve a corrective action that is assigned to the observed error pattern;
execute the corrective action to resolve the error on the group of skipped data records;
re-execute processing of the group of skipped data records in response to the corrective action being completed; and
generate and display a total number of skipped data records that remain after re-execution.

2. The non-transitory computer-readable medium of claim 1, further comprising instructions that when executed by at least the processor cause the processor to:
generate and display a graphical user interface (GUI) on a display screen, wherein the GUI displays the list of error types and allows for selection of an error type; and
display a selectable option to resolve the error type, wherein the selectable option is configured to initiate the execution of the corrective action on the group of skipped data records and to initiate the re-execution processing of the group of skipped data records after the corrective action.

3. The non-transitory computer-readable medium of claim 1, wherein the instructions to re-execute processing further include instructions that when executed by at least the processor cause the processor to:
identify request objects that were involved in the group of skipped data records that had an error while processing, and re-execute the request objects; and
re-invoke the request object for processing.

4. The non-transitory computer-readable medium of claim 1, further comprising instructions that when executed by at least the processor cause the processor to:
define a collection of failure scenarios from a history of observed errors that identifies different conditions of data tables and fields that identify a specific failure pattern;
store and maintain the collection of failure scenarios in the database of observed error patterns; and
wherein each observed error pattern includes an assigned corrective action that is stored in a collection of correction scenarios.

5. The non-transitory computer-readable medium of claim 1, further comprising instructions that when executed by at least the processor cause the processor to:
wherein after re-executing the processing, access the error log to identify and determine the total number of skipped data records that remain after re-execution.

6. The non-transitory computer-readable medium of claim 1, further comprising instructions that when executed by at least the processor cause the processor to:
determine that the error type is a data calculation error that includes a mismatch of data or out-of-sync data between database tables;
identify names of the database tables from the error description which forms part of the error pattern; and
wherein the corrective action includes modifying one or more data values associated with the identified database tables based on the error pattern associated with the error message from the skipped data records.

7. The non-transitory computer-readable medium of claim 1, further comprising instructions that when executed by at least the processor cause the processor to:
from the skipped data records, identify data fields that identify charge amounts and determine an impacted revenue amount that is caused by the skipped data records not being processed to completion; and
display, on the graphical user interface, the impacted revenue amount associated with the skipped records count.

8. A computing system, comprising:
at least one processor connected to at least one memory;
a non-transitory computer readable medium including instructions stored thereon that when executed by at least the processor cause the processor to:
for a selected application that was executed by the computing system, access a system error log and identify error messages that occurred during execution, wherein the error messages include an error description;
parse and analyze the error descriptions from the error messages to identify error messages that have the same or similar error type;
identify skipped data records that were not processed to completion during execution of the application and determine a skipped records count based on the error type;
display, on the GUI, a list of error types that aggregate the error descriptions by error type and display a total number of skipped records associated with each error type;
execute a resolving function to resolve a selected error type that is associated with a group of skipped data records by:
generating an error pattern from an error message from the selected error type by extracting features from the error message;
comparing the error pattern to a database of observed error patterns;
wherein the observed error patterns are previously determined from historical observed errors;
wherein each observed error pattern includes a corrective action assigned to the observed error pattern that is configured to resolve the observed error pattern;
in response to the error pattern matching one of the observed error patterns, retrieving the corrective action that is assigned to the observed error pattern;
executing the corrective action to resolve the error message on the group of skipped data records;
re-executing processing of the group of skipped data records in response to the corrective action being completed; and
generating and displaying a total number of skipped data records that remain after re-execution.

9. The computing system of claim 8, further comprising instructions that when executed by at least the processor cause the processor to:
generate and display a graphical user interface (GUI) on a display screen, wherein the GUI displays the list of error types and allows for selection of an error type; and
display a selectable option to resolve the error type, wherein the selectable option is configured to initiate the execution of the corrective action on the group of skipped data records and to initiate the re-execution processing of the group of skipped data records after the corrective action.

10. The computing system of claim 8, wherein the instructions to re-execute processing further include instructions that when executed by at least the processor cause the processor to:
identify request objects that were involved in the group of skipped data records that had an error while processing, and re-execute the request objects; and
re-invoke the request object for processing.

11. The computing system of claim 8, further comprising instructions that when executed by at least the processor cause the processor to:
define a collection of failure scenarios from the historical observed errors that identifies different conditions of data tables and fields that identify a specific failure pattern, wherein each failure scenario defines an associated observed error pattern; and
store and maintain the collection of failure scenarios in the database of observed error patterns.

12. The computing system of claim 8, further comprising instructions that when executed by at least the processor cause the processor to:
wherein after re-executing the processing, access the error log to identify and determine the total number of skipped data records that remain after re-execution.

13. The computing system of claim 8, further comprising instructions that when executed by at least the processor cause the processor to:
from the skipped data records, identify data fields that identify charge amounts and determine an impacted revenue amount that is caused by the skipped data records not being processed to completion; and
display, on the graphical user interface, the impacted revenue amount associated with the skipped records count.

14. The non-transitory computer-readable medium of claim 8, further comprising instructions that when executed by at least the processor cause the processor to:
determine that the error type is a data calculation error that includes a mismatch of data or out-of-sync data between database tables;
identify names of the database tables from the error description which forms part of the error pattern; and
wherein the corrective action includes modifying one or more data values associated with the identified database tables based on the error pattern associated with the error message from the skipped data records.

15. A computer-implemented method for resolving an error performed by a computing system, the method comprising:
for a selected application that was executed by the computing system, accessing a system error log and identifying error messages that occurred during execution, wherein the error messages include an error description;
parsing and analyzing the error descriptions from the error messages to identify error messages that have the same or similar error type;
identifying skipped data records that were not processed to completion during execution of the application and determine a skipped records count based on the error type;
displaying, on the GUI, a list of error types that aggregate the error descriptions by error type and display a total number of skipped records associated with each error type;
executing a resolving function to resolve a selected error type that is associated with a group of skipped data records by at least:
generating an error pattern from an error message from the selected error type by extracting features from the error message;
comparing the error pattern to a database of observed error patterns;
wherein the observed error patterns are previously determined from historical observed errors;
wherein each observed error pattern includes a corrective action assigned to the observed error pattern that is configured to resolve the observed error pattern;
in response to the error pattern matching one of the observed error patterns, retrieving the corrective action that is assigned to the observed error pattern;
executing the corrective action to resolve the error message on the group of skipped data records;
re-executing processing of the group of skipped data records in response to the corrective action being completed; and
generate and display a total number of skipped data records that remain after re-execution.

16. The method of claim 15, further comprising:
generating and displaying a graphical user interface (GUI) on a display screen, wherein the GUI displays the list of error types and allows for selection of an error type; and
displaying a selectable option to resolve the error type, wherein the selectable option is configured to initiate the execution of the corrective action on the group of skipped data records and to initiate the re-execution processing of the group of skipped data records after the corrective action.

17. The method of claim 15, further comprising:
identifying request objects that were involved in the group of skipped data records that had an error while processing, and re-execute the request objects; and
re-invoking the request object for processing.

18. The method of claim 15, further comprising:
define a collection of failure scenarios from the historical observed errors that identifies different conditions of data tables and fields that identify a specific failure pattern, wherein each failure scenario defines an associated observed error pattern; and
store and maintain the collection of failure scenarios in the database of observed error patterns.

19. The method of claim 15, further comprising:
after re-executing the processing, accessing the error log to identify and determine the total number of skipped data records that remain after re-execution.

20. The method of claim 15, further comprising:
accessing the skipped data records and identifying data fields that identify charge amounts;
determine an impacted revenue amount from the charge amounts that is caused by the skipped data records not being processed to completion; and
display, on the graphical user interface, the impacted revenue amount associated with the skipped records count.
